(19) United States
(12) Patent Application Publication
(10) Pub. No.: US 2007/0233533 A1
(43) Pub. Date: Oct. 4, 2007

(54) SYSTEM AND METHOD FOR CREATING WORK ORDER

(75) Inventors: Yun-Feng Xie, Shenzhen (CN); Chun-Yan Zhu, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/617,751

(22) Filed: Dec. 29, 2006

(30) Foreign Application Priority Data
Mar. 29, 2006 (CN) 200610060106.6

(51) Int. Cl. G06F 9/44

(52) U.S. Cl. 705/7

(57) ABSTRACT

A system for creating a work order is provided, the system comprising an information downloading module, a work order selecting module and a work order creating module. The information downloading module downloads basic work order information. The work order selecting module selects a work order according to the basic work order information, and generates a selection result. The work order creating module creates a work order according to the selection result, and applies a created work order to a corresponding work field. A method for creating a work order is also provided.

### BACKGROUND OF THE INVENTION

1. Field of the Invention

The invention generally relates to a system and method, and particularly to a system and method for creating a work order.

2. Description of Related Art

In a typical production management system, before a work order is applied to a work field, a production supervisor has to log on a system host to obtain product information such as customer order and so on, and then make a work order plan according to the product information. In case that there are too much work orders to be applied, problems may easily arise due to erroneous operation by the production supervisor.

Therefore, a heretofore unaddressed need exists in the industry to overcome the aforementioned deficiencies and inadequacies.

### SUMMARY OF THE INVENTION

A system for creating a work order is provided, the system comprising an information downloading module, a work order selecting module and a work order creating module. The information downloading module downloads basic work order information. The work order selecting module selects a work order according to the basic work order information, and generates a selection result. The work order creating module creates a work order according to the selection result, and applies a created work order to a corresponding work field.

A method for creating a work order is also provided, the method comprising a downloading basic work order information; selecting a work order according to the basic work order information, and generates a selection result; and creating a work order according to the selection result.

Other advantages and novel features will become more apparent from the following detailed description when taken in conjunction with the accompanying drawings, in which:

### BRIEF DESCRIPTION OF THE DRAWINGS

FIG. 1 is a block diagram of a system for creating a work order of an exemplary embodiment of the invention;

FIG. 2 is a flowchart of a method for creating a work order of another exemplary embodiment of the invention;

FIG. 3 is a detailed flowchart of FIG. 2;

FIG. 4 is a flowchart following a node A of FIG. 3; and

FIG. 5 is a flowchart following a node B of FIG. 3.

### DETAILED DESCRIPTION OF THE INVENTION

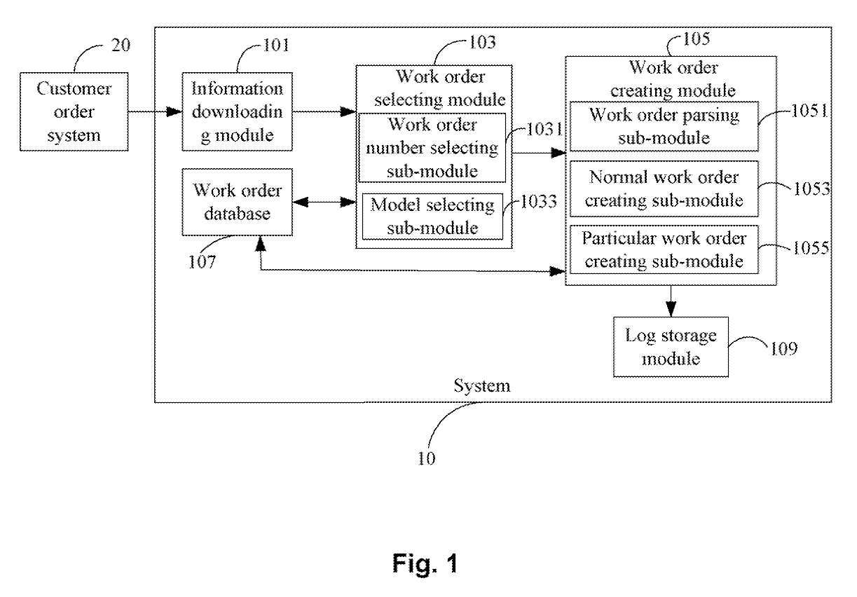

FIG. 1 is a block diagram of a system 10 for creating a work order of an exemplary embodiment of the invention.

The system 10 is communicatively connected to a customer order system 20, and includes an information downloading module 101, a work order selecting module 103, a work order creating module 105, a work order database 107 and a log storage module 109. In this embodiment, the work order includes a normal work order and a particular work order.

The customer order system 20 receives a customer order, to provide basic work order information to the system 10. In this embodiment, the basic work order information includes a work order number, a model, the required number of products, and so on.

The work order database 107 stores created work orders and materials of a model. In this embodiment, the materials include a main material, a sub-material and a key material.

The information downloading module 101 downloads basic work order information from a customer order system 20.

The work order selecting module 103 selects a work order according to the basic work order information, and generates a selection result. The work order selecting module 103 includes a work order number selecting sub-module 1031 and a model selecting sub-module 1033.

The work order number selecting sub-module 1031 selects the work order according to the work order number. In this embodiment, the work order number selecting sub-module 1031 compares work order numbers in the basic work order information with those of the created work orders in the work order database 107, deletes basic work order information corresponding to the created work orders, and maintains basic work order information corresponding to the uncreated work orders.

The model selecting sub-module 1033 selects work orders according to models corresponding to the uncreated work orders. In this embodiment, the model selecting sub-module 1033 determines whether the models are producible, deletes basic work order information corresponding to unproducible models, and maintains basic work order information corresponding to producible models as the selection result.

The work order creating module 105 creates a work order according to the selection result, and transmits a created work order to a corresponding work field. The work order creating module 105 includes a work order parsing sub-module 1051, a normal normal work order creating sub-module 1053 and a particular work order creating sub-module 1055.

The work order parsing sub-module 1051 parses the basic work order information according to the selection result, determines whether the work order is a normal work order or a particular work order according to work order number, and respectively imports the normal work order and the particular work order to a normal normal work order creating sub-module 1053 and a particular work order creating sub-module 1055.

The log storage module 109 writes error information produced during creation of the work order into a log file.

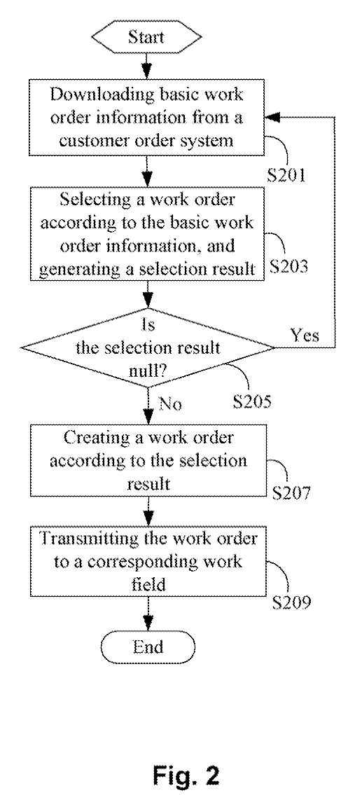

FIG. 2 is a flowchart of a method for creating a work order of another exemplary embodiment of the invention.

In step S201, the information downloading module 101 downloads basic work order information from a customer order system 20.

In step S203, the work order selecting module 103 selects a work order according to the basic work order information, and generates a selection result.

In step S205, the work order selecting module 103 determines whether the selection result is null. If the selection result is not null, the process proceeds to step S207, otherwise the process returns to step S201.

In step S207, the work order creating module 105 creates a work order according to the selection result.

In step S209, the work order creating module 105 transmits the work order to a corresponding work field.

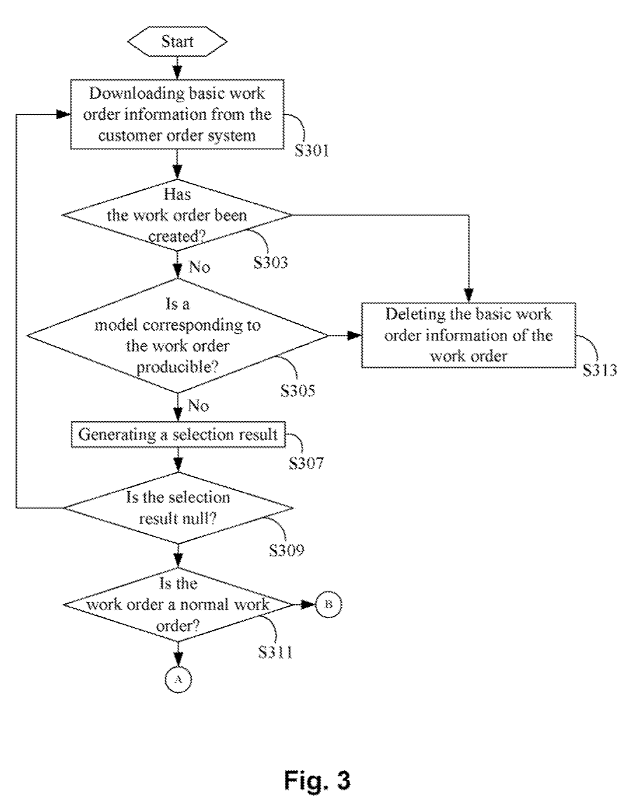

FIG. 3 is a detailed flowchart of FIG. 2.

In step S301, the information downloading module 101 downloads basic work order information from the customer order system 20. In this embodiment, the basic work order information includes a work order number, a model, the required number of products, and so on.

In step S303, the work order number selecting sub-module 1031 compares a work order number in the basic work order information with that of the created work order in the work order database 107, to determine whether the work order has been created. If the work order has not been created, the process proceeds to step S305, otherwise the process proceeds to step S313.

In step S305, the model selecting sub-module 1033 determines whether a model corresponding to the work order is producible. If the model corresponding to the work order is producible, the process proceeds to step S307, otherwise the step S313.

In step S307, the model selecting sub-module 1033 generates a selection result.

In step S309, the work order selecting module 103 determines whether the selection result is null. If the selection result is not null, the process proceeds to step S311, otherwise the process returns to step S301.

In step S311, the work order parsing sub-module 1051 parses the basic work information of the work order, to determine whether the work order is a normal work order.

In step S313, the work order selecting module 103 deletes the basic work order information of the work order.

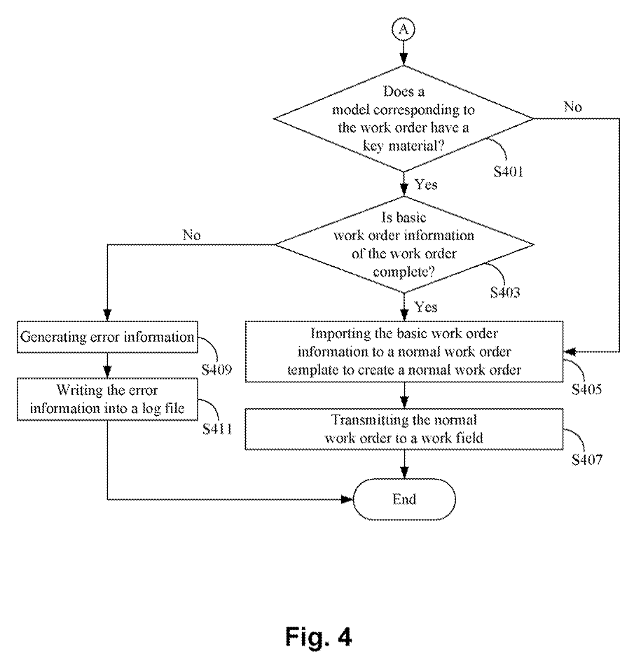

FIG. 4 is a flowchart following a node A of FIG. 3.

In step S401, the work order parsing sub-module 1051 determines whether a model corresponding to the work order has a key material. If the model corresponding to the work order has the key material, the process proceeds to step S403, otherwise the process proceeds to step S405.

In step S403, the normal work order creating sub-module 1053 determines whether basic work order information of the work order is complete. If the basic work order information of the work order is complete, the process proceeds to step S405, otherwise the process proceeds to step S409.

In step S405, the normal work order creating sub-module 1053 imports the basic work order information to a normal work order template to create a normal work order.

In step S407, the work order creating module 105 transmits the normal work order to a work field.

In step S409, the normal work order creating sub-module 1053 generates error information.

In step S411, the log storage module 109 writes the error information into a log file.

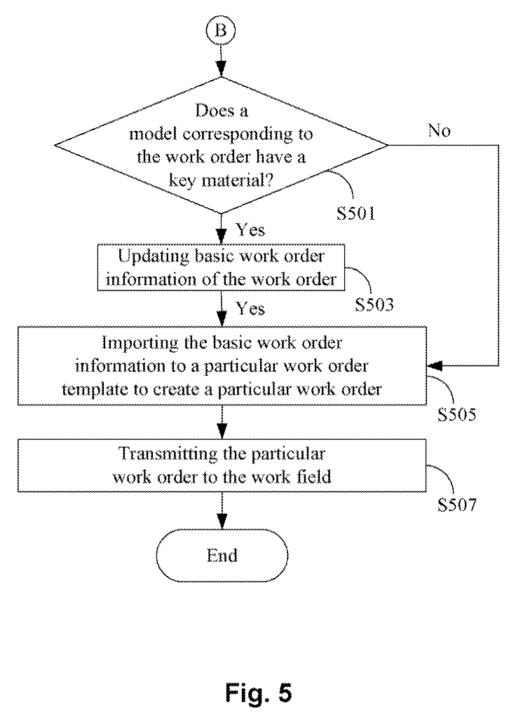

FIG. 5 is a flowchart following node B of FIG. 3.

In step S501, the work order parsing sub-module 1051 determines whether a model corresponding to the work order has a key material. If the model corresponding to the work order has the key material, the process proceeds to step S503, otherwise the process proceeds to step S505.

In step S503, the particular work order creating sub-module 1055 updates basic work order information of the work order.

In step S505, the particular work order creating sub-module 1055 imports updated basic work order information to a particular work order template to create a particular work order.

In step S507, the work order creating module 105 transmits the particular work order to the work field.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A system for creating a work order, comprising:
an information downloading module for downloading basic work order information from a customer order system;
a work order selecting module for selecting a work order according to the basic work order information, and for generating a selection result; and
a work order creating module for creating a work order according to the selection result, and for transmitting a created work order to a corresponding work field.

2. The system in accordance with claim 1, further comprising a work order database for storing a created work order and a material of a model.

3. The system in accordance with claim 2, wherein the model comprises a main material, a sub-material and a key material.

4. The system in accordance with claim 1, wherein the basic work order information comprises a work order number, a model, and the required number of products.

5. The system in accordance with claim 4, wherein the work order selecting module comprises:
a work order number selecting sub-module for selecting the work order according to the work order number; and
a model selecting sub-module for selecting the work order according to model corresponding to a work order selected by the work order number selecting sub-module.

6. The system in accordance with claim 5, wherein the work order creating module comprises:
a work order parsing sub-module for parsing the basic work order information according to the selection result; and
a normal work order creating sub-module for creating a normal work order according to a parsed basic work order information; and
a particular work order creating sub-module for creating a particular work order according to the parsed based work order information.

7. The system in accordance with claim 1, further comprising a log storage module for writing error information produced during creation of the work order into a log file.

8. A method for creating a work order, comprising:
downloading basic work order information from a customer ordering system;
selecting a work order according to the basic work order information, and generating a selection result; and
creating a work order according to the selection result.

9. The method in accordance with claim 8, further comprising:
determining whether the selection result is null; and
creating the work order according to the basic work order information if the selection result is not null.

10. The method in accordance with claim 9, further comprising continuing downloading the basic work order information from the customer ordering system if the selection result is null.

11. The method in accordance with claim 10, wherein the basic work order information comprises a work order number, a model, and the required number of products.

12. The method in accordance with claim 11, wherein the step of selecting a work order according to the basic work order information comprises:
determining whether the work order has been created according to the work order number;
determining whether a model of the work order is producible if the work order has not been created;
deleting basic work order information of the work order if the model of the work order is unproducible.

13. The method in accordance with claim 12, further comprising deleting the basic work order information of the work order if the work order has been created.

14. The method in accordance with claim 8, wherein the step of creating a work order according to the selection result comprises:
determining whether the work order is a normal work order or a particular work order according to the work order number;
determining whether a model of the work order has a key material if the work order is a normal work order;
determining whether the basic work order information of the work order is complete if the model of the work order has a key material; and
importing the basic work order information to a normal work order template to create a normal work order if the basic work order information of the work order is complete.

15. The method in accordance with claim 14, further comprising:
determining whether a model of the work order has a key material if the work order is a particular work order; and
importing the basic work order information to a particular work order template to create a particular work order if the model of the work order has no key material.

16. The method in accordance with claim 15, further comprising
updating basic work order information of the work order if the model has a key material; and
importing an updated information of the work order to the particular work order template to create the particular work order.

17. The method in accordance with claim 15, further comprising:
generating an error information if the basic work order information is not complete; and
writing the error information into a log file.
